(19) United States
(12) Patent Application Publication
(10) Pub. No.: US 2021/0339286 A1
(43) Pub. Date: Nov. 4, 2021

(54) Separation Apparatus and Method; Apparatus and Method for Bringing Articles in a Layer

(71) Applicant: Urban Mining Corp B.V., Rotterdam (NL)

(72) Inventors: Peter Carlo REM, Rijswijk (NL); Simon Petrus Maria BERKHOUT, Delft (NL); Cornelis VAN BEEK, Lisse (NL); Pingping WEN, Delft (NL); Cornelis Gustav Karl LÖHLEFINK, Voorburg (NL); Bernardus VAN DEN BOSCH, Moerkapelle (NL)

(21) Appl. No.: 17/250,981

(22) PCT Filed: Oct. 7, 2019
(86) PCT No.: PCT/NL2019/050668

§ 371 Date: Apr. 6, 2021

(30) Foreign Application Priority Data
Oct. 8, 2018 (NL) 2021777

(51) Int. Cl. B07B 13/11; B07B 13/04; B07B 13/16

(52) U.S. Cl. CPC B07B 13/11; B07B 13/04; B29B 2017/0279; B07B 2220/02; B07B 2230/01; B07B 13/16

(57) ABSTRACT

A separation apparatus is disclosed, comprising: a layerizer arranged to bring a group of particles in a layer on a transport surface with a constant spatial relation of the particles relative to each other in the layer; an identifier arranged to identify particles in the group of particles that have a specific property; a separator arranged to separate the particles in the group based on a difference in affinity between the particles and the separator; an affinity modifier arranged to modify said affinity for identified particles relative to non-identified particles in the group. The layerizer comprises a recirculating transport surface on which the particles of the layer are carried. The transport surface is arranged to move along a transport trajectory as a rigid plane. Further, a method for separation of particles from a group of particles is disclosed.

The invention generally relates to separation of particles, in particular in recycling.

Separation apparatus are known in the prior art and they are typically used in raw materials processing for the classification of mixed streams of particles of recycling material into streams with particles of different types of material.

In WO2016089209 a separation apparatus is proposed that comprises:
a layerizer arranged to bring a group of particles in a layer on a transport surface with a constant spatial relation of the particles relative to each other in the layer;
an identifier arranged to identify particles in the group of particles that have a specific property;
a separator arranged to separate the particles in the group based on a difference in affinity between the particles and the separator;
an affinity modifier arranged to modify said affinity for identified particles relative to non-identified particles in the group; wherein
the layerizer comprises a recirculating transport surface on which the particles of the layer are carried along a transport trajectory. In the known apparatus, the recirculating transport surface may be formed by an endless conveyor belt that is arranged as a flexible plane to support a layer of particles, the identifier may comprise a camera to identify particles in the group that have a certain color, the affinity modifier may comprise a printer head arranged to wet identified particles from a group of particles individually, the separation device may comprise a passive separator onto which the particles fall, and the separator may comprise a hydrophilic contact surface so as to attract the wetted particles in the group.

This separation apparatus is intended for economic recycling of a mixed stream of smaller particles of physically similar or identical particles, e.g. shredded particles of a plastic material, e.g. PET or PE, having different colors and a maximum dimension of several mm, e.g. 20 mm or less.

Although this known apparatus includes many advantages, it also has a number of disadvantages. In particular, it has proven difficult in practice to accurately modify the affinity for identified particles, e.g. to wet plastic flakes of smaller size, and to ensure adherence of the identified particles to the separator.

The invention aims at alleviating one or more of the aforementioned disadvantages. In particular, the invention aims to provide a sensor separation apparatus with improved accuracy and efficiency. To that end, the invention provides for a separation apparatus, comprising:
a layerizer arranged to bring a group of particles in a layer on a transport surface with a constant spatial relation of the particles relative to each other in the layer;
an identifier arranged to identify particles in the group of particles that have a specific property;
a separator arranged to separate the particles in the group based on a difference in affinity between the particles and the separator;
an affinity modifier arranged to modify said affinity for identified particles relative to non-identified particles in the group; wherein
the layerizer comprises a recirculating transport surface on which the particles of the layer are carried along a transport trajectory, wherein
the transport surface is arranged as a rigid plane so as to limit movement of the particles transverse to the transport trajectory.

By arranging the transport surface to move along a transport trajectory as a rigid plane, it may be achieved that movement of the particles transverse to the transport trajectory is limited, so that the cooperation between the identifier and the affinity modifier can be more precise, and the position and energy level upon delivery of the particles from the transport surface to the separator can be more accurately controlled. By providing such a plane that is arranged to resist bending as recirculating transport surface instead of the flexible body of an endless conveyor belt typically used as recirculating transport surface, the actual position of particles on the belt surface along the trajectory becomes much more predictable. In accordance with the invention, a planar transport surface is provided that is rigid compared to a planar transport surface of an endless conveyor belt that is flexible, and that bends about an axis transverse to the conveying direction to allow recirculation of the conveyor belt about divert wheels. By providing a transport plane that is stiff enough to retain its shape during use, the accuracy of the affinity modifier may be further increased, and accidentally modifying an affinity of the non-identified particles may be prevented. In addition, the control of the speed when casting off the surface can be precisely controlled, so that the ability of the separator to interact with the identified particles may be increased. Further, the increased predictability provided by the rigid planar transport surface allows successful indirect application of affinity modifying particles, i.e. applying the affinity modifying particles to the catch surface.

That the transport surface is arranged to move along the transport trajectory as a rigid plane may within this context be construed that when moving along the transport trajectory, the relative position of any two points on the transport surface remains substantially constant, e.g. to the degree that variations in position of a particle on the transport surface are such that they allow the modification of the affinity of particles on the transport surface with a positional accuracy that is in the order of magnitude of the spatial accuracy of the identifier and/or the affinity modifier for the particles on the transport surface. The transport surface thus during use forms a rigid body, i.e. a body that substantially retains its shape. As an alternative or in addition, the transport surface being arranged to move along the transport trajectory as a rigid plane may within this context be construed as that when moving along the transport trajectory, the maximum percentage of deviation of the particles from the transport trajectory due to imprecisions, flexing or bending of the transport plane, i.e. transverse displacement of the particles relative to displacement of the particles along on the transport trajectory is less than 1 mm, in particular less than 0.5 mm, and more in particular less than 0.2 mm.

Within this context, the term ‘group of particles’ may be construed as a set of particles that at a point in time is arranged in a layer on a transport surface with a constant spatial relation of the particles relative to each other in said layer. The group of particles may e.g. be physically embodied as a subset of all the particles that are present on the transport surface at a given point in time, and may in particular be those particles which are present in a scanning window of an identifier that is projected onto the transport surface.

Within this context, the term ‘non-identified particles’ may be construed as particles for which the specific property has not been identified. ‘Non-identified particles’ may thus be the set of particles of the group of particles that is complementary to the set of ‘identified particles’ of the group. The ‘identified particles’ may e.g. be the particles of the group for which the specific property has been positively identified, and the ‘non identified particles’ may then be the remaining particles of the group. The term ‘non-identified particles’ may be construed as the ‘other’ particles in the group. Non-identified particles may within this context thus include particles that as such have been identified as to their type and/or composition by the identifier, but for which the presence of the specific property has not been identified. Non-identified particles may in fact have the specific property, but their identification as a having the specific property may not have taken place, e.g. due to an error, due to too low a content of the specific property, or due to intentional non-identification.

By arranging the transport surface to rotate, it may be facilitated that the rigid planar transport surface can be made to recirculate relatively easily. The transport surface may e.g. be embodied as the face of a rotationally disposed disc, e.g. a stiff flat disc.

By embodying the transport surface as a mantle surface, e.g. the mantle surface of a rotational body such as a (frustrated) cone it may be facilitated that all areas of the transport surface have a desired minimum rotational speed. In such embodiment, the planar surface may be a curved planar surface instead of a flat planar surface. When the transport surface is the mantle surface of a cylinder, it may be facilitated that all points on the transport surface have the same speed. In such embodiment, the planar transport surface may be a planar surface having a single, constant radius of curvature.

When the transport surface is embodied as a rotating mantle surface of a drum it may be facilitated that further features are provided, e.g. sides of the drum closing off the mantle surface may be used to house a chamber within the drum, and the body of the drum may also be used to support the mantle surface so that it can be made to rotate as a rigid plane relatively simply. The transport surface may in a particularly elegant embodiment be a mantle surface that is arranged to rotate about a stationary support core of a drum.

By arranging the transport trajectory to include a particle delivery zone where the particles disengage the transport surface to become airborne and travel along a flight path to the separator, it may be achieved relatively simply that the particles leave the transport surface to interact with the separator. Preferably, the air velocity along the flight path to the separator is controlled such that the particles travel along the flight path with a velocity that is substantially the same as the particle transport velocity on the transport surface and/or a catch surface of the separator. This may e.g. be achieved by passing an entrainment air stream along the flight path. The entrainment air stream extends along the flight path from the particle delivery zone to the particle pickup zone. The entrainment air stream may elegantly be chosen such that the particles in the flight path are entrained to have substantially the same velocity as the transport surface and/or the catch surface. To provision of the transport surface as a rigid element combined with the possibility of matching the travel velocity of the particles along the flight path with the transport velocity of the transport surface and/or the catch surface allows for very precise control over the spatial distribution of the particles in the resulting array of the particles when airborne, and when interacting with the catch surface of the separator.

When the particle delivery zone includes a part of the transport trajectory where the transport surface moves downward, it may be achieved relatively easily that the particles are cast off of the transport surface due to their inertia. The catch surface may then be located either higher or lower than the particle delivery zone. Alternatively, the particles may e.g. be caused to fall off the transport surface due to gravity in a part of the transport trajectory where the transport surface moves upward. The catch surface may then typically be located lower than the particle delivery zone. As yet another alternative or in addition, the particles may be blown off the transport surface, e.g. towards the separator, using an air flow. This allows increased control of the path and velocity of the particles during flight.

The transport trajectory may include a particle pickup zone where the particles engage the transport surface. The transport surface and/or the particles may be arranged to promote a light affinity for each other to promote engagement of the particles to the transport surface at the particle pickup zone. The particle pickup zone may e.g. include a part of the transport trajectory where an inside of the mantle surface passes along a zone were air pressure is arranged to be lower than at the outside of the transport surface, and where particles are sucked onto the transport surface by ambient air passing through apertures in the transport surface. The flow of air is identified by arrows P3. This way, arranging the particles in a layer on the transport surface may be facilitated. The zone where air pressure is arranged to be lower may e.g. extend up to the particle delivery zone, so that the particles stay securely positioned on the transport surface. At the delivery zone, the suction force may then be reduced or stopped, so that the gravitational force, the drag force exerted by air jet and/or centrifugal force exerted by rotation exceeds any forces that tend to keep the particles on the transport surface.

The separation apparatus comprises a layerizer arranged to bring the group of particles in layer. This way, a planar array of particles may be provided so that identification can be facilitated and the particles may be provided with a known spatial relation. This way, it may also be counteracted that too many particles stick onto each other. Also it may be counteracted that e.g. two or more particles are overlapping each other such that the identifier is unable to identify the lower particles.

The layerizer provides the particles in the layer with a known, and constant, spatial relation. The particles may, for example be in a top layer wherein the particles are non-overlapping, or in a monolayer. The particles may be conveyed along the identifier, affinity modifier and the separator with a velocity that may range in between 0.5-8 m/s, preferably 1-3 m/s and more preferably of about 2.5 m/s.

The group of particles may be brought in a layer arrangement by, for example, feeding the group of particles from a conveyor belt, through a channel, sieve, groove, slit, or slot or by means of a sweeper. Further, it is noted that the layerizer may also comprise a density separator, in particular a pulsating density separator, e.g. a jig, causing a pulsation such that the particles may be positioned in a layer arrangement and/or bed and thus the identifier can easily identify at least one specific property of the particles, e.g. of the particles positioned in a top layer of the bed.

The layerizer may comprise a fluidized bed of particles that is maintained at the pickup zone, and wherein the particles are sucked onto the transport surface from the fluidized bed. The fluidized bed may e.g. be arranged in an air gap that extends at the particle pickup zone between the transport surface and a guide that extends along a segment of the transport surface. The guide may e.g. comprise apertures for passing air therethrough. By blowing air into the air gap, a turbulent stream of air can be maintained in the gap. The turbulent stream of air in the gap assists heavier, thicker particles in engaging the transport surface, and assist in fully covering the transport surface with a single layer of particles. For example, near the entrance of the air gap, the transport surface may easily become covered with thinner, lighter particles, so that heavier particles would tend to bounce off and fall down without contacting the transport surface again. The turbulent air stream of the fluidized bed in the air gap then assists such particles to reengage the transport surface further down in the air gap, where the transport surface still has free space for the particles to be sucked onto the surface. The turbulent air stream may also assist in assuring that the particles are attached to the transport surface in a single layer only, as particles that are overlapping an underlying particle do not receive sufficient suction force to resist being blown off the surface by the turbulent air stream. Any particles that fail to engage the transport surface may e.g. be returned to the feed, or may be discarded. This arrangement is particularly effective when the particle pickup zone is located in a part of the transport trajectory where the transport surface moves upward, so that excess of particles may fall off the transport surface due to gravity. The layerizer may further include a particle feed to feed particles into air gap, and an air inlet for blowing air into the gap to assist in fluidizing the particles.

The transport surface may be provided with a plurality of apertures for passing air therethrough. The transport surface may e.g. be embodied as wire mesh, or as a sheet with a plurality of apertures sized smaller than particles.

Outside the particle pickup zone, the transport surface may be arranged to pass along a further stationary compartment within the support core of the drum where air pressure is the same as ambient, and/or to pass along a pressurized compartment at the delivery zone located in the core of the drum where particles are blown off the mantle surface of the drum by air passing through apertures in the mantle surface towards the ambient. The separation apparatus may comprise an air pump with an air inlet that is arranged to suck air away from the inside of the drum and an air outlet. The air outlet may e.g. be arranged to blow particles off the drum surface towards the separator, to fluidize the particles in the air gap between the mantle surface and the guide, and or to pressurize the compartment in the drum at the delivery zone so as to blow air out via the apertures in the transport surface.

By providing the separation apparatus with an affinity modifier, it may be achieved that only the identified particles, e.g. particles that are commercially relevant, may be separated from the group based on a provided difference in the affinity without disturbing neighboring non-identified particles. This way, accidentally separating a non-identified particle may be counteracted, and thus the accuracy of separation may be high.

The affinity of the particle for the separator may be modified, anchor the affinity of the separator for the particle may be modified. The affinity modifier modifies the tendency of the particles and the separator to affix to each other. Preferably, the affinity modifier increases this tendency. For example, the affinity modifier may be arranged to modify the force of attraction or attachment force of the identified particles relative to that force of attraction or attachment force of non-identified particles in the group, such that identified particles may be attracted onto the separator. The tendency may be increased by means known in the art, for example, increasing the adhesiveness of the particles and/or the separator, but also by statically charging the particles and/or the separator, or using magnetization of the particles and/or the separator. The modifier may alternatively also reduce this tendency.

It is noted that the affinity modifier is arranged to modify the affinity for the identified particles relative to that affinity of non identified particles. This may e.g. comprise the following four situations: (1) the identifier identifies particles that are commercially relevant and the affinity modifier may then be arranged to change the affinity between the identified particles and the separator such that a separator can separate the identified particles from the group, e.g. by picking or engaging the particles, or (2) the identifier identifies particles that are commercially relevant and the affinity may then be arranged to change the affinity between the non-identified particles and the separator such that the separator can separate the non-identified particles from the group, or (3) the identifier identifies particles that are not commercially relevant. The affinity modifier may then be arranged to change the affinity between the non-identified particles and the separator such that the separator can separate the non-identified particles from the group, or (4) the identifier identifies particles that are not commercially relevant and the affinity modifier may then be arranged to modify the affinity between the identified non-commercially relevant particles and the separator such that the separator can separate the identified non-commercially relevant particles from the group. It is noted that the identifier selectively and individually engages the particles, i.e. each particle of the group is being engaged and identified by the identifier. Identifying the particles that are commercially relevant and changing the affinity between the identified particles and the separator such that a separator can separate the identified particles from the group may typically yield the most pure stream of identified particles: the identifier can be very precise and taking the identified particles out from the group can reduce the risk that unsuccessful engagement causes contamination of the stream of separated commercially relevant particles.

The affinity modifying particles may form a layer onto the identified particles, the non-identified particles or the catch surface.

The affinity modifying particles may be liquid droplets. In a particularly environmentally friendly and effective embodiment, the liquid droplets may comprise water to form a moisture bridge between the identified particles and the separator.

The affinity modifier may modify the affinity of the identified particles for the separator or vice versa by applying affinity modifying particles to the identified particles, in particular to increase the affinity between the identified particles and the catch surface of the separator. The affinity modifying particles may be applied directly to the identified particles, e.g. the identified particles on the mantle surface of the drum may be wetted and the catch surface may comprise hydrophilic material so that the wetted particles get caught, and the particles that are not identified remain dry and deflect from the catch surface.

Alternatively, the affinity modifier may modify the affinity of the catch surface for identified particles or vice versa by applying affinity modifying particles to the catch surface of the separator, in particular corresponding to that particles' spatial relation to the other particles in the layer on the transport surface. The catch surface may then e.g. be wetted at a location that corresponds to an identified particle in the layer on the mantle surface of the drum, and identified particles may upon impact with the locally wetted catch surface become wet to some extent and stick to the wetted area, while particles that impact at dry areas of the catch surface stay dry and deflect from the catch surface. As an alternative, the particles and/or the catch surface may e.g. be electrostatically charged using charge particles, e.g. electrons.

By providing the separation apparatus with a separator, it may be achieved that, e.g. the identified particles with a modified affinity may be selectively separated from the group, and the non-identified particles may remain undisturbed. Consequently, the particles may then be arranged more closely together, and thus increasing the capacity and the economy of the process. As an option, it is noted that once the separator has separated the identified particles from the group, a second separator or more separators arranged in one go may additionally be included to separate remaining particles of a different type of material, color, or size, and thus more than one type of particle may be separated from a single sorter system.

In a particularly efficient embodiment, the separator may comprise a catch surface on which identified particles in are caught, preferably a recirculating catch surface. Such catch surface may in particular be used to catch particles that have become airborne at the delivery zone and that have travelled along the flight trajectory and impact the catch surface of the separator. The catch surface may be a mantle surface that is arranged to rotate as a rigid body.

The particles may travel upward along the flight trajectory onto the catch surface, e.g. by arranging the catch surface upward of the delivery zone. This way, the force of gravity may assist in preventing accidental affixation of non-identified particles to the catch surface. This increases the purity of the stream of identified particles that is recovered via the separator. Alternatively, the particles may travel downward along the flight trajectory onto the catch surface, e.g. by arranging the catch surface downward of the delivery zone. This way, the force of gravity may assist in ensuring that an identified particle is affixed to the catch surface. This increases the volume of the stream of identified particles that is recovered via the separator.

Elegantly, the separator may be embodied as a further drum. The separator may further include a scraper, e.g. a blade, air knife or dryer to remove caught particles and/or moisture from the catch surface.

The particles in the group may be small particles of, e.g. plastic, metal and/or wood, with a diameter that may range between 1-20 mm. The particles may typically be plastic flakes, e.g. originating from shredded recycled plastic bottles. The specific property may also be thin wires or small pieces of rare earth metals that are recovered from shredded electronics waste. The particles may e.g. be wire segments with a diameter of 0.2 mm or larger, and a length of 2-30 mm. The minimum dimension of the particles may thus e.g. be 0.2 mm, and the maximum dimension may thus e.g. be 30 mm.

The identifier may identify the particles in the group on the basis of a specific property, e.g. material type, weight, color, shape and/or size. Specifically, non-physical property, e.g. same density but different color, or size out of a specified range. For example, a particle of the group may be identified with the specific property of color while another particle of the group may be identified with the specific property of size. It is noted that the identifier may be arranged to identify multiple specific properties, however, it is also possible to have multiple identifiers aligned in a row, each identifier arrange to identify at least one specific property. Transport trajectory may include an identification zone where the transport trajectory extends along the identifier.

The identifier may be a sensor, e.g. optical sensor and/or an image processing device, e.g. color camera (RGB) for visual assessment of color, a contrast camera for shape assessment e.g. using back lighting, an IR camera for temperature and shape assessment, near-infrared (NIR) camera for chemo-spectral and shape assessment (e.g. plastic type), X-ray methods such as X-ray Fluorescence (XRF) for elemental assessment or X-ray transmission for density and shape assessment, or laser induced breakdown spectroscopy (LIBS) for elemental assessment. The optical sensor may for example have a resolution in time of better than 0.5 ms and a resolution in space of better than 0.5 mm. Therefore, the optical sensor may accurately define the position, size and/or shape of particles passing by.

The affinity of the identified particles which may be modified by the affinity modifier may be e.g. the adhesiveness e.g. using water or spray able adhesive on plastic flakes, electric static charge or magnetic behavior of the identified particles. In particular, the affinity modifier may modify the affinity of the identified particles by applying affinity modifying particles to the identified particles, wherein the modifying particles may contain or include charged particles, e.g. electrons to statically charge the identified particles.

Preferably, the affinity modifying particles may be material particles. In such case, the affinity changing particles may form a layer onto the identified particles. Additionally or alternatively, the affinity changing particles may form, at least partially, a layer onto the identified particles, i.e. onto a surface of the identified particles that is facing the affinity modifier. For example, modifying particles may be discharged from the modifier from above the conveyor such that the modifying particles may adhere onto the surface of the particles, forming a sticky, moisturized and/or magnetic or magnetizable coating surface.

The affinity modifying particles discharged from the affinity modifier may e.g. be charge particles, e.g. to electrostatically charge the catch surface at a location that corresponds to the position of a particle to be caught. In such case, the affinity modifier may e.g. be an electron beam, laser or a spray of charged water droplets.

The affinity modifying particles discharged from the affinity modifier may be also liquid droplets and/or powder particles. The affinity modifier may comprise jets, e.g. jet printer heads. When the affinity modifier discharges liquid droplets, this may for example be oil, alcohol, but preferably water to moisturize the identified particles. The identified particles may then be covered by a water layer of approximately 10-20 microns thickness. The liquid droplets on the surface of the identified particles may then form a moisture bridge between the identified particles and the separator while the non-identified particles remain substantially dry. Optionally, it is also possible that the liquid droplets on the surface of the identified particles form a moisture bridge between the identified particles and a second material, e.g. powder particles, wherein the powder particles may be discharged by, for example, another affinity modifier, e.g. powder spray, after the identified particles have been moisturized.

The affinity modifier is arranged for individual engagement of particles. The affinity modifier may deliver over 50,000 droplets per second per valve, wherein each droplet may have a diameter smaller than 100 micron and preferably 60 micron. The valves may be spaced from each other with a distance of about 0.05 mm or more. In particular, the valves are preferably arranged for providing droplets at a resolution of 100 droplets per inch—or 39 to 40 droplets per centimetre.

The affinity modifier may comprise a print head of the type used in ink-jet printing, e.g. continuous ink jet type print head or a drop on demand ink jet type print head. The droplet speed may e.g. be in the range of 10-30 m/s, and may in particular be about 20 m/s, and the firing frequency of droplets may e.g. be in the range of 50,000-150,000 Hz. The volume of the droplets ejected by the ink jet print head are preferably significantly larger than typically used for ink jet printing, e.g. an ejected volume of the print head of 20 ml/s.

It is noted that multiple modifiers or one modifier having multiple valves may be arranged in a row that is transverse to the conveyor direction, or they may be partly co-moving in the direction of the conveyor to eliminate the relatively motion between the modifier and particles during the modifying action (e.g. spraying jets mounted on a device rotating opposite to the conveyor belt). Each valve and/or modifier may contain different modifying particles to be discharged. By having the modifier that is able to deliver over 50,000 droplets per second per valve, it may be achieved that the accuracy between the sensor and the separator may be better coordinated. In particular, the resolution of the separator may be about 0.4 mm and thus it easily matches the resolution of the identifier of 0.5 mm and therefore the separator may operate with the same accuracy as the identifier.

It is noted that besides the above mentioned fluids, it is also possible that the modifier discharges glutinous fluids onto the identified particles, e.g. starch.

The powder particles may be a magnetic or magnetizable powder, e.g. industrial Ferrosilicon, preferably spherically shaped. Preferably, the modifier discharges powder particles after the particles have been at least partially covered by liquid droplets. For example, 40-150 micron magnetic or magnetizable powder particles may be added per moisturized identified particles such that the powder will stick onto the moisturized identified particles.

Elegantly, the affinity modifier may comprise a printer head. In principle, conventional heads may be used. However, the spacing between the nozzles may be increased. Preferably, the affinity modifier comprises a printer head wherein the printer head may be of the type inkjet printer for discharging the liquid droplets. The affinity modifier may further comprise a powder spray arranged to discharge the powder particles, e.g. Ferrosilicon. Thus, the printer head is arranged to discharge water droplets onto the identified particles after which the powder spray sprays spherically shaped Ferrosilicon on the moisturized identified particles. The droplets may thus form a water bond, with a strength comparable with a yellow sticky note, between the identified particles and the Ferrosilicon. By providing the identified particles with liquid droplets and a layer of Ferrosilicon, the identified particles may be selectively attracted to a magnet or a magnetizable material.

The separator may have a contact surface onto which the identified particles are affixed thereon. The separator may be arranged to individually engage the particles. The separator may have a visco-elastic catch surface, to prevent or reduce that particles bounce off the catch surface. The separator may be an active separator i.e. a separator that is mechanically driven to ensure that the contact surface engages the identified particles and/or the group of particles. However, it is also possible to have a passive separator, i.e. wherein the identified particles and/or group of particles fall onto the contact surface of the separator. The contact surface may be coated with a hydrophilic material arranged to attract the moisturized particles. The contact surface may also be a magnet or at least is coated with a magnetizable layer arranged to interact with the magnetic or magnetizable spherically powder particles that may be on the surface of the identified particles such that the identified particles may be attracted by the separator, or affix onto it. An advantage of a separator having a contact surface onto which the identified particles are affixed, in particular with the surface coated with a hydrophilic material and/or the separator having magnetic properties, is that no pressing of the separator on the identified particles is required for adherence of the particles to the separator. This enables short processing times. And in particular in the case of affixing by means of magnetic attraction, an additional advantage is that particles other than identified particles are not in contact with the separator, which reduces the odds of non-identified particles 6 to be picked up by the separator.

The separator may be a mechanical pick up device having a contact surface that contacts the group of particles for picking up the identified particles. The separator may, for example, be a drum with a rotating axis transverse to the conveyor direction. The drum may have a contact surface that is coated with a magnetizable layer or with hydrophilic fibrous material with fibers having a size that may range in between 100-500 micron diameter and is preferably about 300 micron diameter.

The invention further relates to a method for separation of particles from a group of particles, comprising the steps of:
providing a group of particles that comprises particles with different properties, e.g. material, color, shape and/or size;
supplying the group of particles to a transport surface that moves along a transport trajectory as a rigid plane so as to bring the group of particles in a layer with a constant spatial relation on the transport surface;
identifying particles in the group of particles that have a specific property;
modifying an affinity between the identified particles and a separator relative to that affinity between non-identified particles and the separator using an affinity modifier;
separating the particles in the group based on their difference in the affinity with the separator.

The method may further include
casting the particles off the transport surface to become airborne and travel along a flight path to a catch surface of the separator.

As an alternative or in addition, the method may include
modifying the affinity of the identified particles by applying affinity modifying particles to the identified particles and/or the catch surface to increase the affinity between the identified particles and the catch surface.

The invention will be further elucidated on the basis of an exemplary embodiment which is represented in a drawing. In the drawings:

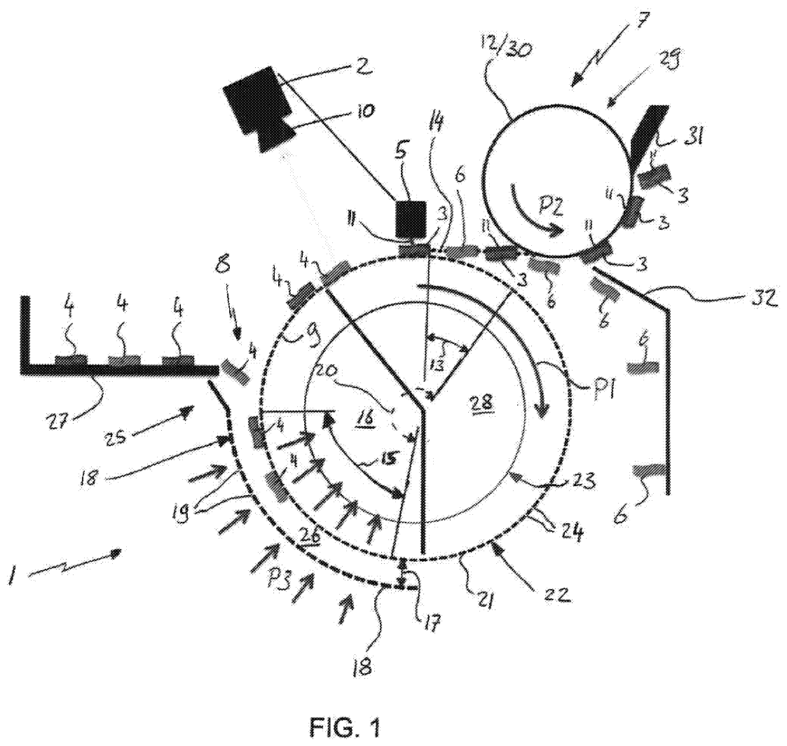

FIG. 1 shows a schematic view of a first embodiment of the separation apparatus.

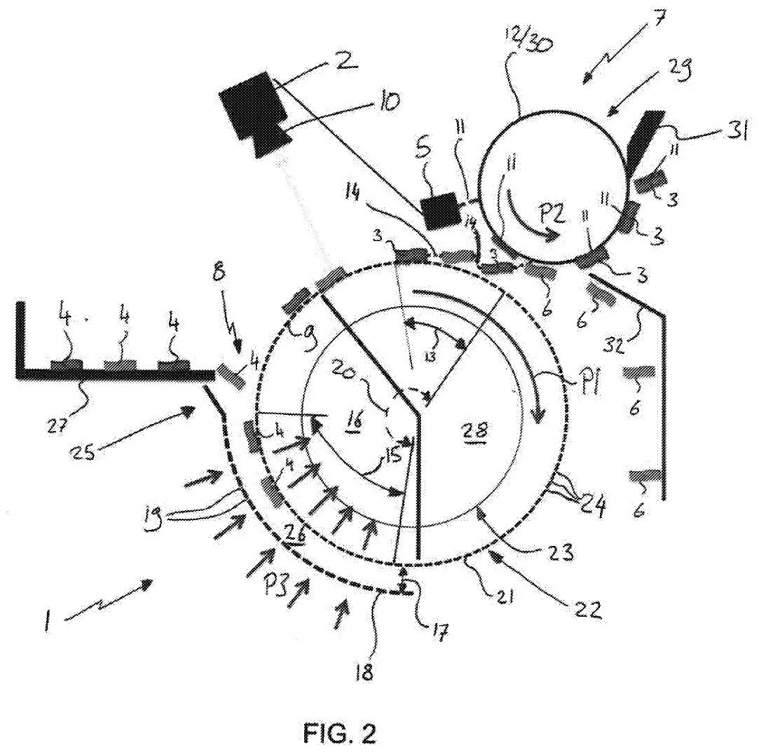

FIG. 2 shows a second schematic view of a second embodiment of the separation apparatus.

It is noted that the figures are merely schematic representations of a preferred embodiment of the invention, which is given here by way of non-limiting exemplary embodiment. In the description, the same or similar part and elements have the same or similar reference signs.

In FIG. 1 is shown a first embodiment of a separation apparatus 1 comprising an identifier 2 arranged to identify the particles 3 in a group of particles 4 that have a specific property. A specific property that is measured or otherwise assessed by the identifier 2 may e.g. be a type of material, weight, color, shape and/or size.

The separation apparatus 1 is arranged for individual engagement of particles. The particles may be small particles such as shredded PE, PP or PET of different colors or different grades with a diameter size that may range between 1-20 mm.

A separator 7 is provided that is arranged to separate the particles in the group 4 based on a difference in affinity between the particles and the separator 7. The separator 7 has a catch surface 12 onto which identified particles 3 adhere such that they can be separated from the group particles 4.

An affinity modifier 5 is provided that is arranged to modify said affinity for identified particles 3 relative to non-identified particles 6 in the group.

The sensor separation apparatus 1 comprises a recirculating transport surface 9 on which particles 4 are carried. The recirculating transport surface 9 here forms part of a layerizer 8 that is arranged to bring the group of particles 4 in a layer. It provides the particles 4 in the layer on the recirculating transport surface 9 with a known constant spatial relation in the layer between at least the identifier 2 and the affinity modifier 5. The transport surface 9 is arranged to move along a transport trajectory 20 as a rigid plane. The rigid plane is formed by the mantle surface 21 of a transport drum 22 that rotates about a center axis of the drum 22 in the direction of arrow P1. The drum comprises a core 23, which supports the mantle surface 21. The support core may close off the mantle surface at the sides, so as to complete a chum shape. In this embodiment, the mantle surface 21 rotates about the core 23. It shall be clear that it is also possible to embody the transport drum 22 so that the mantle surface 21 rotates together with the core 23. The transport surface 9 is here provided with a plurality of apertures 24 for passing air therethrough, and may in particular be a wire mesh that is supported stiffly on the stationary core 23 of the transport drum 22 to be able to rotate as a rigid plane. In particular, the mantle surface 21 is a rigid plane in that it is kept from bending about an axis that extends along the axis of rotation of the transport drum 22. The apertures 24 in the wire mesh are sized smaller than the particles, so that the particles cannot pass through the apertures.

In this embodiment, both the identifier 2 and the affinity modifier 5 are located along the transport trajectory 20, in particular above the transport trajectory. Due to the mantle surface 21 recirculating rigidly about the center axis, and e.g. not needing to flex to round a divert wheel, the distance between any two points on the transport surface 9 can stay substantially constant. This way, it can be ensured in practice that the position, speed and the travel time of an identified particle 3 from the identifier 2 along the transport trajectory 20 to the affinity modifier 5 is known. This allows operation of the identifier 2 and the affinity modifier 5, and optionally also the separator 7 to be synchronized with high precision.

The layerizer 8 in this embodiment comprises a transport surface 9 on which the particles are deposited in a planar layer. As shown in FIG. 1 the group particles 4 are fed onto the mantle surface 21 of the transport drum 22 that forms the recirculating transport surface 9 by a feed device 25. The feed device 25 forms part of the layerizer 8. The group particles 4 may be fed by such feed device 25 onto the transport surface 9 as a continuous curtain of particles or as sections with a predetermined distance. As shall be discussed further on in more detail, in this example the feed device 25 includes a fluidized bed 26 of particles 4 to ensure that the mantle surface 21 of the transport drum 22 is covered with particles 4 in a monolayer that has a thickness of only one particle.

The identifier 2 is in FIG. 1 embodied as an optical sensor 10 that is positioned above the transport surface 9 to identify the group particles 4 that have a specific property. For example, the identifier 2 is arranged to identify the color of the particles 4 in a stream of clear and in particular translucent particles. The identifier 2 is also arranged to identify a specific type of PP via a marker and/or additive provided in the PP material. Furthermore, the identifier 2 is arranged to identify the position of the particles on the transport surface 9.

After the particles 4 have passed along the identifier 2, the affinity modifier 5 in this example modifies the affinity of the identified particles 3 by applying affinity modifying particles 11 directly to the identified particles 3. The modifying particles 11 are here discharged from above the transport surface 9 such that the affinity modifying particles 11 form a layer onto the identified particles 3. The affinity modifying particles 11 are here discharged with a component of their velocity parallel to the motion of the transport surface 9. In this way, it may be avoided that identified particles 3 are missed by the particles by time of flight effects related to variations in the height of the identified particles above the transport surface 9.

The affinity modifying particles 11 may in FIG. 1 be liquid droplets and/or powder particles. The liquid droplets in this example are water droplets to moisturize the identified particles to form a moisture bridge between the identified particles 3 and the separator 7. The water may be provided with a minor amount of additives to improve the electrical conductivity. A reason for this is that some printers require the liquid to be disposed to have a certain electrical conductivity for properly discharging the liquid. This applies not only to ink, but also to water in case water is to be discharged by the printer. Optionally, it also possible that after the identified particles 3 have been moisturized by liquid droplets, a second modifier (not shown) or the same modifier discharges a second material, preferably powder particles. The powder particles in FIG. 1 may be magnetic or magnetizable powder particles, e.g. industrial ferrosilicon wherein they are preferably spherically shaped such that the identified particles 3 may be engaged individually and/or lifted by the separator 7.

The affinity modifier 5 is in FIG. 1 embodied as a printer head for distributing water or another liquid for moisturizing the liquid droplets. The printer head 5 is arranged for providing droplets smaller than 100 micron, preferably 30 to 60 micron. The droplets are preferably provided at a resolution of at least 100 droplets per inch—or 39 to 40 droplets per centimetre. At this resolution, it is possible to deposit liquid only on identified particles 3. Additionally to this, powder particles may be discharged on either identified particles 3 only or on all particles. On identified particles 3, powder particles are bound by the liquid on the identified particles 3. Powder particles on other particles 6 may be removed, for example by means of blowing or a magnetic field. Alternatively, in an embodiment in which liquid as well as powder particles are discharged, liquid is deposited at all particles 4 on the conveying surface 9 and the powder particles are only discharged on the identified particles 3.

If identified particles are moisturized, this may be done in a blanket fashion, deploying a blanket or substantially continuous film of liquid on either all particles 4 or identified particles 3. Alternatively, liquid is discharged on specific areas. This may for example be established by depositing the liquid in lines. These lines may be parallel to the motion of the transport surface, perpendicular to the motion of the transport surface, or under an angle relative to the motion of the transport surface.

In certain embodiments, it may be desired to pretreat the particles 4 for improving adherence between affinity modifying particles and the group particles 4. To this purpose, a pre-treatment module (not shown) may be provided for pretreating the group particles 4. If the affinity modifying particles comprise water, it may be preferred to improve hydrophilic properties of the group particles 4. In one specific embodiment, a very thin layer (1 to 10 nanometers) of calcium carbonate is applied to the group particles. Such layer of calcium carbonate may be applied by exposing the group particles to water having a sufficiently high hardness (measured, for example, in German degrees) at a temperature of at least 80 degrees centigrade. Exposure may be provided by means of spraying or submersion. Submersion is preferably done for at least 30 seconds, in water of sufficient hardness, at a temperature of at least 80 degrees. Alternatively or additionally, a coating of for example hexamethyldisilazane and/or other hydrophilic substances may be provided as a coating for the group particles 4. The coating may be applied on all particles or on identified particles 3 only. Alternatively, a hydrophobic coating may be applied, e.g. to non-identified particles.

Thus, a separation apparatus 1 is disclosed, comprising: a layerizer 8 arranged to bring a group of particles 4 in a layer on a transport surface 9 with a constant spatial relation of the particles relative to each other in the layer; an identifier 2 arranged to identify particles 3 in the group of particles 4 that have a specific property; a separator 7 arranged to separate the particles in the group 4 based on a difference in affinity between the particles and the separator 7; an affinity modifier 5 arranged to modify said affinity for identified particles 3 relative to non-identified particles 6 in the group of particles 4. The layerizer 8 comprises a recirculating transport surface 9 on which the particles of the layer are carried. The transport surface 9 is arranged to move along a transport trajectory 20 as a rigid plane.

As can be seen in FIG. 1, the transport trajectory 20 includes a particle delivery zone 13 where the particles disengage the transport surface 9 to become airborne and travel along a flight path 14 to the separator 7. The particle delivery zone 13 includes a part of the transport trajectory 20 where the transport surface 9 moves downward. At the delivery zone 13, the particles are cast off of the transport surface 9 due to their inertia.

The transport trajectory 20 further includes a particle pickup zone 15 where the particles engage the transport surface 9. The particle pickup zone 15 includes a part of the transport trajectory 20 where the inside of the mantle surface 21 passes along a zone 16 were air pressure is arranged to be lower than at the outside of the transport surface 9, and where particles are sucked onto the transport surface 9 by ambient air passing through apertures 24 in the transport surface 9. The zone 15 with reduced air pressure is embodied as a vacuum chamber in the stationary core 23 of the transport drum 22. In this embodiment, the transport trajectory 20 further includes an identification zone where the transport trajectory 20 extends along the identifier 2.

The layerizer 8 comprises as feeder device 25 a fluidized bed 26 of particles that is maintained at the particle pickup zone 15. The particles are sucked onto the transport surface 9 from the fluidized bed 26. The fluidized bed 26 is arranged in an air gap 17 that extends at the particle pickup zone 15 between the transport surface 9 and a guide 18. The guide 18 extends along a segment of the transport surface 9, and comprise apertures 19 for passing air therethrough. The layerizer 8 further includes a vibrating feed plate 27 to feed particles into the air gap 17.

Outside the particle pickup zone 15, at the delivery zone 13 where particles are thrown off the mantle surface 21, the transport surface 9 is arranged to pass along a further compartment 28 within the support core 23 of the transport drum 22 where air pressure is the same as the ambient air pressure. To facilitate casting off of the particles, the air pressure inside the drum may at the delivery zone be increased slightly compared to the outside. The separation apparatus 9 comprises an air pump (not shown) with an air inlet that is arranged to suck air away from the inside of the drum, i.e. from the reduced pressure camber or ‘vacuum’ chamber 16, so that air pressure in that part of the inside of the drum is lower than ambient. An air outlet of the pump is arranged to assist in fluidizing the particles in the air gap 17 between the mantle surface 21 and the guide 18.

The separator 7 comprises a catch surface 12 on which identified particles 3 are caught to effect separation. The separator 7 is in this example embodied as a catch drum 29 that rotates in the direction of arrow P2. The catch drum 29 has a rotating catch surface. The axis of rotation of the catch drum is perpendicular to the conveying direction, i.e. parallel to the axis of the transport drum 22. The mantle 30 of the catch drum 29 is covered with hydrophilic material, which forms a recirculating catch surface 12. Particles that have become airborne at the delivery zone and that have travelled along the flight trajectory impact on the catch surface 12 of the separator 7. The identified particles 3 of which the affinity has been modified by droplets of water, adhere to the catch surface 12. The separator 7 includes a scraper 31, e.g. embodied as a blade to remove the caught particles 3 from the catch surface 12. For the particles 6 that have not been identified, the affinity with the separator 7 has not been modified, and has remained low. These particles 6 deflect off the catch surface 12 of the separator 7, and fall down while being guided along a guide plate 32 that keeps them separate from the particles 3 that are scraped off the catch drum 29.

In this embodiment, the affinity modifier 5 thus modifies the affinity of the identified particles 3 by applying affinity modifying particles 11 to the identified particles 3, in particular to increase the affinity between the identified particles 3 and the catch surface 12. The affinity modifying particles 11 are here applied directly to the identified particles 3, i.e. the identified particles 3 on the mantle surface 21 of the transport drum 22 are wetted. The mantle surface 30 of the catch drum 29 is dry and comprises hydrophilic material so that the wetted identified particles 3 get caught due to the formation of moisture bridges, and the particles 6 that are not identified remain dry and deflect from the mantle surface 30.

In the embodiment shown in FIG. 2, the affinity modifier cooperates with the catch surface of the separator. In this embodiment, the affinity modifier 5 modifies the affinity of the catch surface 12 by applying affinity modifying particles 11 to the catch surface 12 of the separator 7, in particular corresponding to that identified particles' position on the transport surface. In this embodiment, the mantle surface 30 of the catch drum 30 is wetted at a location that corresponds to a position of an identified particle 3 in the layer on the mantle surface 21 of the transport drum 22, corrected for its travel along the transport trajectory 20 and its expected movement along the flight path 14. The wetted location may e.g. be seen as a projected footprint of the particle on the catch surface. Upon impact with the catch surface 12 after the flight path 1, the identified particle 3 sticks to the wetted area of the mantle surface 30 due to the formation of moisture bridges. Particles that impact at dry areas of the mantle surface 12 stay dry and deflect from the catch surface. The speed of the catch surface is preferably made to correspond with the speed of the particle on the transport surface and in the flight path. For example, the circumferential speed of the catch drum is made to correspond to the circumferential speed of the transport chum, and an air jet may be provided to blow the particles along the flight path so that their flight speed is kept the same as the circumferential speeds of the drums. Elegantly, in an arrangement where the catch drum is positioned downstream and above the transport drum, the transport drum and the catch drum may be provided with the same diameter, and may be driven by the same motor via a transmission drives both drums in the same ratio, but with their sense of rotation inverted. The drums may rotate e.g. at one rotation per second.

By localized wetting of the catch surface of the catch drum it may be achieved that identified particles that are not wetted easily, e.g. thin metal wire segments from shredded electronics waste, may be caused to adhere to the catch surface drum. To prevent such particles from passing through the transport surface, the transport surface may e.g. be embodied as a closed surface. Further, it may be achieved that the identified particles can be separated while transferring relatively little liquid to the identified particles, which conserves energy when drying the stream of identified particles that are recovered via the separator. The catch surface of the catch drum may be dried off or otherwise regenerated to receive new affinity modifying particles after the identified particles have been removed from the surface.

Elegantly, the catch drum in this embodiment has a mantle surface that is made of abrasion resistant material, e.g. polyurethane.

The catch surface is preferably embodied as a rigid plane, similar to the transport surface.

Further, the catch surface and the transport surface may be provided with a surface with a low coefficient of restitution, e.g. 0.2 or less. A low coefficient of restitution prevents that the identified particles bounce off the catch surface. The coefficient of restitution is defined herein as the inverse of the ratio of the momentum of a particle on its way to impact the catch surface to that of the particle bouncing off the catch surface. In particular, the catch surface may be embodied as a visco-elastic surface. This can reduce the chance that identified particles bounce off the catch surface in spite of the affinity between the particle and the catch surface having been increased by application of affinity modifying particles on the particle and/or the catch surface, and may in particular provide that that the particles drop dead on the catch surface of the separator.

Thus is disclosed a method for separation of particles from a group of particles 4, comprising the steps of: providing a group of particles 4 that comprises particles with different properties, e.g. material, color, shape and/or size; supplying the group of particles 4 to a transport surface 9 that moves along a transport trajectory 20 as a rigid plane so as to bring the group of particles in a layer with a constant spatial relation on the transport surface 9; identifying particles 3 in the group of particles 4 that have a specific property; modifying an affinity between the identified particles 3 and a separator 7 relative to that affinity between non-identified particles 6 and the separator 7 using an affinity modifier 5, and separating the particles in the group based on their difference in the affinity with the separator 7. The particles of the group 4 are cast off the transport surface 9 to become airborne and travel along a flight path 14 to a catch surface 12 of the separator 7. The affinity of the identified particles is modified to increase the affinity between the identified particles 3 and the catch surface 12. In the first embodiment this is done by applying affinity modifying particles 11 directly to the identified particles 3. In the second embodiment this is done indirectly by applying affinity modifying particles 11 to the catch surface 12 at the position where the identified particle 3 impacts the catch surface 12.

As for the extent of this disclosure, it is pointed out that technical features which have been described may be susceptible of functional generalization. It is further pointed out that—insofar as not explicitly mentioned—such technical features can be considered separately from the context of the given exemplary embodiment, and can further be considered separately from the technical features with which they cooperate in the context of the example.

Further details of particles separation and in particular the use of magnetic and magnetizable powder are disclosed in document WO2016089209, the contents of which document are incorporated herein by reference.

It is pointed out that the invention is not limited to the exemplary embodiments represented here, and that many variations are possible. For example, the identifier may also be an identifier station comprising multiple identifiers arranged in a row or the separation apparatus may comprise multiple identifiers stations, preferably also arranged in a row. There may also be an affinity modifier station or a separator station.

Further, it is noted that the separator and the affinity modifier may be accommodated in a single device wherein modifying the affinity of identified particles and separation may be single action and may take place at the same time at a same position.

It is further noted that multiple separation apparatus may be placed in one go, e.g. above a conveyor, such that multiple different particles may be separated from a single stream of particles.

In addition, the transport surface and/or catch surface may be closed, e.g. in case it is used for particles that would pass through apertures, and/or e.g. in case of wetting of the transport and/or catch surface.

Also, it is noted that the separator may be embodied as a mechanical pick up device of which a contact surface contacts the group of particles for picking up the identified particles. Further, in case ferrosilicon particles are used to modify the affinity of the particles by forming hydrogen bridges with wetted, identified particles, it is also possible that the separator is embodied a magnet or that its contact surface is a magnet, has magnetic properties, or at least is coated with a magnetizable layer. In addition, if the separator is a magnet or its catch surface is a magnet, or at least is coated with a magnetizable layer, the separator may be used to recover magnetic or magnetizable particles that may have been discharged upstream.

These and other embodiments will be apparent to the person skilled in the art and are considered to lie within the scope of the invention as formulated by the following claims.

Aspects of the invention relate to a layering apparatus and a method for bringing a group of particles in a layer.

In many technical areas it can be beneficial to bring a group of particles, e.g. particles to be processed, in a layer. Such a layer may be for example a layer with a substantially single-particle thickness throughout the layer, for example substantially a monolayer-like layer of particles. A spatial particle density and/or a ratio between particle-filled space and other space, may be substantially constant throughout the layer. Thus, the particles may be distributed substantially evenly throughout the layer. In many applications, it is preferred that such a layer is substantially dense (i.e. substantially non-sparse) with particles, while overlap of particles along the layer is substantially limited. Such a layer of particles can enable that particles in the layer may be processed, e.g. analyzed and/or treated, efficiently and effectively.

A particular application which can benefit from such a layer relates to separation of particles, in particular for recycling purposes. The particles may be flake-shaped, e.g. plastic or glass, particles, for example produced by cutting, shredding and/or crushing waste, e.g. post-consumer waste, packaging waste and/or electronic waste. One aim of such an application is typically to separate particles according to one or more particle material properties (e.g. chemical composition, material density, color) and/or one or more particle geometry properties (e.g. size, shape, position).

For example, in such an application, a particle identifier and/or a particle separator can benefit from receiving particles to be identified and/or separated in such a substantially dense, monolayer-like configuration. While such a particle identifier and/or particle separator can often cope with a more sparse layer, their efficiency tends to reduce with increasing layer sparseness. For example, sensors, e.g. cameras, and/or ejectors, e.g. jets, that are used to respectively recognize and/or eject individual particles can operate more efficiently on more dense layers, while they also tend to operate less efficiently and/or less effectively when particles overlap more or more often.

A known method of bringing particles in a layer-like formation uses a vibratory feeder with its producing edge positioned above the surface of a conveyor. The particles drop from the edge of the feeder onto the surface of the conveyor, usually at a horizontal velocity which is less (e.g. about an order of magnitude less) than a respective horizontal velocity of the conveyor. When the particles drop from the feeder, they typically tumble as they pick up speed from direct or indirect contact with the conveyor. It has been found that this method tends to result in particles being distributed substantially randomly along the conveyor surface, wherein particles often overlap along said surface (e.g. particles are often at least partially on top of or below another particle) and/or wherein spatial particle density along the conveyor surface is relatively low with particles being distributed sparsely along the conveyor surface. In such a method, particle sparseness and particle overlap can sometimes be traded against each other, e.g. by adjusting a conveyor velocity with respect to a particle feeding rate of the feeder. However, such a method lacks the desired possibility of a combined reduction of particle sparseness and particle overlap.

In WO2016089209 a separation apparatus is proposed that comprises i.a. a layerizer arranged to bring a group of particles in a layer, wherein the layerizer comprises a recirculating transport surface on which the particles of the layer are carried along a transport trajectory.

Although this known apparatus includes many advantages, it also has a number of disadvantages. In particular, the use of a recirculating transport surface on which the particles of the layer are carried along a transport trajectory may have one or more disadvantages depending on the specific application. For example, such a recirculating transport surface may be relatively costly, susceptible to wear, and/or may occupy a relatively large space.

An object of the present invention, which object is related to the above-mentioned aspects, is to provide an alternative apparatus and method for bringing a group of particles in a layer. In this respect a particular object is to provide such an alternative apparatus which is less costly, more durable and/or more compact.

To that end, one aspect of the above-mentioned aspects of the present invention provides a method for bringing a group of particles in a layer.

The method comprises for each one particle of the group of particles: accelerating the one particle along a particle transport path, thereby spacing the one particle apart from at least one other particle of the group of particles; receiving the one particle on a particle receiving surface which extends along the particle transport path, thereby contributing the one particle to a layer of particles of the group of particles which layer is thereby formed on the particle receiving surface; and decelerating the accelerated one particle on the particle receiving surface along the particle transport path, thereby reducing a distance along the particle receiving surface between the one particle and at least one neighboring particle of the formed layer of particles.

It has been found that a group of particles can thus advantageously be brought in a layer, in particular a layer with one or more desired or advantageous properties such as a low particle sparsity and/or a low amount of particle overlap, in particular in a more economic and/or more reliable way and/or with reduced use of space compared to one or more known methods.

In particular, by thus accelerating the particles, overlap between the particles (in particular along the particle transport direction) may be advantageously reduced. Receiving the particles on the particle receiving surface enables the formation of a particle layer on said surface by the accelerated particles, in particular a relatively sparse and substantially a monolayer-like layer. Sparsity of the layer can subsequently be reduced by thus decelerating the particles on the particle receiving surface, in particular with no or at least relatively limited increase of overlap of particles.

It will be appreciated that the particle receiving surface itself may or may not move along the particle transport path. For example, particles may slide over the particle receiving surface. Some or all of the formed layer may leave the particle receiving surface, e.g. at a downstream and of said surface, e.g. as a substantially continuous stream of particles in a layer. Optionally, the accelerated one particle may be additionally decelerated, e.g. by a flow of fluid, while not on the particle receiving surface, e.g. prior to being received and decelerated on the particle receiving surface.

The accelerated one particle is preferably decelerated by friction between the one particle and the particle receiving surface.

It has been found that good particle deceleration can be realized in this way, so that in particular layer sparsity can be reduced while increase of particle overlap can be substantially limited.

The one particle may be accelerated along the particle transport path by a force of gravity acting on said one particle.

In this way a stable particle acceleration can be realized with relatively simple means.

Alternatively or additionally, a flow of fluid, e.g. air, may be provided along the particle transport path, wherein the one particle is accelerated along the particle transport path by said flow of fluid.

Good results have been obtained in this way. For example, the particles may be at least partly suspended in the fluid due to a relatively high-speed fluid flow. The fluid flow may be turbulent near a particle, which may further promote that particles are separated from each other.

At least one, preferably each, particle of the group of particles may be accelerated and/or decelerated at a different time and/or at a different rate and/or from a spaced apart position compared to at least one, preferably each, other particle of the group of particles.

In this way, the particles may be distributed substantially sparsely with limited or no overlap between particles. For example, particles may be fed into the accelerator at at least somewhat different times and/or at at least somewhat spaced apart positions, which differences may subsequently be amplified by the acceleration. Advantageous differences in acceleration and/or deceleration rates may result from (possibly small) differences between particles such as size, shape and/or mass differences.

The one particle may be accelerated along the particle transport path to a respective increased particle velocity along the particle transport path, wherein said increased particle velocity exceeds a velocity of the particle receiving surface along the particle transport path.

Thus, the particle may be decelerated by friction with the particle receiving surface upon being received on said surface.

The accelerated one particle may be decelerated along the particle transport path to a reduced particle velocity along the particle transport path, wherein said reduced particle velocity is equal to or exceeds said velocity of the particle receiving surface, wherein said reduced particle velocity is less than said increased particle velocity.

In this way, particles can be substantially prevented from reversing direction along the particle transport path, which could otherwise result in disadvantageous overlap between particles.

Each particle may be accelerated such that overlap of particles along the particle transport path is reduced, wherein each accelerated particle is decelerated such that sparsity of the formed layer of particles is reduced.

It will be appreciated that appropriate acceleration and deceleration profiles are dependent on i.a. specifics of the particles. Relevant examples are provided later on in the description.

Preferably (but not necessarily) each accelerated particle is decelerated such that the formed layer is a layer with a substantially constant spatial relation of the particles relative to each other in the layer.

For example, the particles may be brought in contact with each other by the deceleration such that their relative spatial positions in the layer become substantially constant. Alternatively or additionally, if desired, the formed layer may be processed further after the deceleration wherein the further processing modifies the layer such that the modified layer is a layer with a substantially constant spatial relation of the particles relative to each other in the layer.

The method may further comprise passing the layer of particles from the particle receiving surface to a downstream conveyor and conveying the layer on the downstream conveyor further along the particle transport path at a predetermined conveyor velocity which is defined relative to a rate at which the layer is passed to the downstream conveyor, thereby adjusting at least one of a particle overlap and a particle sparsity of the layer.

For example, it is thus possible to set the conveyor velocity slightly higher than the rate at which the layer is passed to the downstream conveyor, so as to create a slightly less dense (more sparse) layer of particles on the conveyor with a further reduced overlap of particles. Conversely, it is similarly possible to decrease sparseness and/or slightly increase overlap. Thus, a trade-off between sparseness and overlap can be made in this way, depending on application preferences, so that such a trade-off need not or not entirely be incorporated in the design of other parts of the method (although that it will be appreciated that such incorporation is also possible).

The method may further comprise subjecting, in particular upon the receiving, the received one particle to a reception force, for example a centrifugal force, which has a substantially non-zero component perpendicular to and towards the particle receiving surface.

Said reception force is preferably larger than a force of gravity acting on said one particle, more preferably at least double said force of gravity, more preferably at least five times said force of gravity, more preferably at least ten times said force of gravity, for example about twenty times said force of gravity.

It has been found that such a reception force can substantially inhibit received particles, often to a surprisingly large degree, from sliding over each other along the particle receiving surface and thus from overlapping on the particle receiving surface.

Another aspect provides a layering apparatus for bringing a group of particles in a layer. The layering apparatus comprises: a particle accelerator for accelerating particles of the group of particles along a particle transport path; and a particle receiving surface extending along the particle transport path for receiving particles of the group of particles and for decelerating received accelerated particles along the particle transport path, preferably downstream of the particle accelerator. The layering apparatus is configured to form a layer of particles of the group of particles on the particle receiving surface.

The above described method for bringing a group of particles in a layer can be performed using such a layering apparatus. In this way, the layering apparatus provides the above-mentioned advantages.

The particle receiving surface may be configured to decelerate received accelerated particles by friction between the particle receiving surface and the received particles.

At least one of a surface roughness, a material property, a shape and an orientation of the particle receiving surface may be configured to promote friction between the particle receiving surface and the received particles.

It will be appreciated that such friction can thus be promoted to an appropriate degree in various ways. Relevant examples are provided later on in the description.

The particle accelerator may be configured to accelerate particles of the group of particles by allowing said particles to be accelerated by a force of gravity acting on said particles, wherein, at the particle accelerator, the particle transport path extends in an at least partially downward direction.

Alternatively or additionally, the particle accelerator may be configured to provide a flow of fluid, e.g. air, along the particle transport path such that particles of the group of particles are accelerated by said flow of fluid.

The layering apparatus may further comprise a downstream conveyor configured to receive the layer of particles, in particular from the particle receiving surface, and for conveying the layer of particles further along the particle transport path at a predetermined conveyor velocity which is defined relative to a rate at which the layer is passed to the downstream conveyor such that at least one of a particle overlap and a particle sparsity of the layer is adjustable by the downstream conveyor.

One advantage of such a downstream conveyor which may be separate from the particle receiving surface is that the particle receiving surface can be substantially static, thus simplifying design and operation. In particular, the particle receiving surface can thus more easily be made to have an appropriate orientation, smoothness, curvature and/or material for its function in receiving and decelerating particles and forming a layer of particles.

The particle receiving surface may include a curved section along a respective curved section of the particle transport path 50. In this way, the layering apparatus, in particular the particle accelerator and the curved section, can be configured to subject particles received on the particle receiving surface to a centrifugal force which has a substantially non-zero component perpendicular to and towards the particle receiving surface.

Said centrifugal force is preferably larger than a force of gravity acting on a respective particle, more preferably at least double said force of gravity, more preferably at least five times said force of gravity, more preferably at least ten times said force of gravity, for example about twenty times said force of gravity.

Such a curved section can provide effective and robust means of subjecting particles to said centrifugal force, in particular in collaboration with the particle accelerator. Such a centrifugal force can substantially inhibit received particles, often to a surprisingly large degree, from sliding over each other along the particle receiving surface and thus from overlapping on the particle receiving surface

A further aspect of the invention provides a separation apparatus, comprising a layering apparatus as described above for bringing a group of particles in a layer. The separation apparatus further comprises: an identifier arranged to identify particles in the group of particles that have a specific property; a separator arranged to separate the particles in the group based on a difference in affinity between the particles and the separator; and an affinity modifier arranged to modify said affinity for identified particles relative to non-identified particles in the group.

A further aspect of the invention provides a method for separation of particles from a group of particles, wherein the method comprises: providing a group of particles that comprises particles with different properties, e.g. material, color, shape and/or size; and bringing the group of particles in a layer as described above.

The method for separation of particles further comprises: identifying particles in the group of particles that have a specific property; modifying an affinity between the identified particles and a separator relative to that affinity between non-identified particles and the separator using an affinity modifier; and separating the particles in the group based on their difference in the affinity with the separator.

Thus, an alternative apparatus and alternative method for separation of particles is provided, which can in particular be less costly, more durable and/or more compact compared to a known apparatus and/or a known method.

The above-mentioned aspects will be further elucidated on the basis of exemplary embodiments which are represented in drawings. In the drawings:

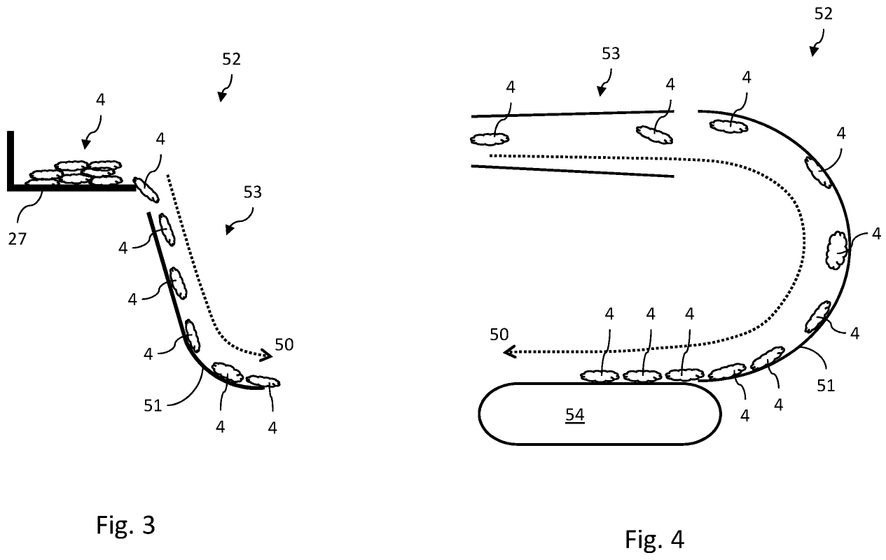

FIG. 3 shows a schematic view of a first embodiment of the layering apparatus; and

FIG. 4 shows a schematic view of a second embodiment of the layering apparatus.

It is noted that the drawings are merely schematic representations of preferred, but non-limiting, embodiments of the invention. In the drawings, similar or corresponding elements have been provided with similar or corresponding reference signs.

FIGS. 3 and 4 show a respective first and second embodiment of a layering apparatus 52 for bringing a group of particles 4 in a layer. It will be appreciated that features of these embodiments are not mutually exclusive and that such features may be advantageously combined.

The layering apparatus 52 comprises a particle accelerator 53 for accelerating particles of the group of particles 4 along a particle transport path 50.

The layering apparatus 52 further comprises a particle receiving surface 51 extending along the particle transport path 50 for receiving particles of the group of particles 4 and for decelerating received accelerated particles along the particle transport path 50, preferably downstream of the particle accelerator 53.

As shown, the layering apparatus 52 is configured to form a layer of particles of the group of particles 4 on the particle receiving surface 51.

As shown in FIG. 3, particles from the group of particles 4 may be fed into the particle accelerator by a feeder, e.g. a feed plate 27, which may be for example a vibratory feeder.

In the shown embodiments, the particle receiving surface 51 is configured to decelerate received accelerated particles by friction between the particle receiving surface 51 and the received particles. A slope of the particle receiving surface 51 as shown in FIGS. 3 and 4 decreases along the particle transport path 50 so that particles are decelerated by friction which substantially increases with the decreasing slope.

Alternatively or additionally, for example, surface roughness, a material property, a shape and/or an orientation of the particle receiving surface 51 can be configured to promote friction between the particle receiving surface 51. Such friction typically partly depends on properties of the particles. Thus, as will be appreciated, one or more properties of the particle receiving surface 51 may be selected depending on such particle properties. For example, in the case of relatively smooth particles, a relatively rough particle receiving surface 51 may be selected.

The particle receiving surface 51 may include a curved section 51 along a respective curved section of the particle transport path 50. In this way, the layering apparatus may be configured to subject particles received on the particle receiving surface 51 to a centrifugal force which has a substantially non-zero component perpendicular to and towards the particle receiving surface 51.

In the embodiment of FIG. 3, the particle accelerator 53 is configured to accelerate particles of the group of particles 4 by allowing said particles to be accelerated by a force of gravity acting on said particles, wherein, at the particle accelerator 53, the particle transport path 50 extends in an at least partially downward direction. For example, the particle accelerator 53 may thus comprise a slide or a chute.

In the embodiment of FIG. 4, the particle accelerator 53 is configured to provide a flow of fluid, e.g. air, along the particle transport path such that particles of the group of particles 4 are accelerated by said flow of fluid. For example, the particle accelerator 53 may thus comprise a fluid flow channel and a fluid pump, e.g. an air pump.

FIG. 4 further shows a downstream conveyor 54 configured to receive the layer of particles, in particular from the particle receiving surface 51, and for conveying the layer of particles further along the particle transport path 50 at a predetermined conveyor velocity. The predetermined conveyor velocity is defined relative to a rate at which the layer is passed to the downstream conveyor. In this way at least one of a particle overlap and a particle sparsity of the layer is adjustable by the downstream conveyor 54.

With additional reference to FIGS. 1 and 2, it will be appreciated that the layering apparatus 52 may advantageously be used as an alternative to a part of the separation apparatus 1, in particular a part upstream of the flight path 14. The layering apparatus 52 may also advantageously be used by addition to the separation apparatus 1 as shown in FIGS. 1 and 2, for example upstream of the transport drum 22, wherein the layering apparatus 52 can for example advantageously reduce a particle layer thickness upstream of the transport drum 22.

While the invention has been explained using exemplary embodiments and drawings, it will be appreciated that these are not intended as limiting the scope of the invention, which scope is provided by the claims. For example, the invention may be applied in other areas than recycling. The layering apparatus may or may not comprise a downstream conveyor and may or may not comprise a feed plate. The layer may be passed and/or processed downstream of the layering apparatus in various ways. For example, the layer may be fed onto a conveyor such as a conveyor belt and/or a conveyor drum and/or onto a slide plate and/or the layer may be dropped from an edge to form a layer-like curtain of particles. Particles may be accelerated by gravity, by a fluid flow, and/or by other means. A layer of particles formed by the method may or may not be a monolayer of particles and the layer may or may not be substantially sparse. A reception force may be a centrifugal force and/or another type of force, e.g. a suction force effected by suction of a fluid, e.g. air, through a fluid-transmissive (e.g. porous) part of the particle receiving surface. Particles may be of various shapes and sizes and/or varying in terms of other properties. For example, one, some or all of the particles may be flake-like particles. In a formed layer, particles may or may not be in contact with each other and may or may not overlap each other. Particles in the layer formed in the layering apparatus and/or by the method for bringing particles into a layer may or may not have a constant spatial relation relative to each other in the layer. These and other variations, alternatives and combinations are possible, as will be appreciated by the skilled person.

In the following, a first and a second example will be provided of a method according to the invention for bringing a group of particles in a layer. It will be appreciated that these examples are provided only for elucidation of the invention and that they are in no way to be construed as limiting the scope of the invention, which scope is provided by the claims.

### FIRST EXAMPLE

Suppose that an objective is, in this first example, to create a dense monolayer-like layer of flake-like particles (flakes) with about 40% particle coverage of a conveyor surface area at about 2 m/s transport velocity of the conveyor. The flakes have a thickness of about 0.5 mm and a diameter in the range of about 2 to about 12 mm and they have mostly irregular shapes, for example pentagonal shapes. Then the flakes could be accelerated first to about 8 m/s and deposited as a sliding flow at this velocity on the particle receiving surface. Because the slicing flow initially has an about four times higher velocity than the conveyor, the flakes will initially form a layer that has a particle coverage of only about 10% of the surface. At this low coverage, few flakes will overlap. Surprisingly, the actual flake overlap rate seen in experiments is often even less than predicted from random deposition experiments. It is often observed that the flakes are arranged in a substantially tile-like pattern without any visible overlap. A possible explanation for this is that the high flake speed of the flakes creates sufficient contact and drag forces to make the position of one flake on top of another into an unstable state. The sliding flow decelerates on the particle receiving surface and the flakes hit each other in the ever denser flow, while the flakes do not tend to slide over one another and so a dense monolayer-like layer is formed.

### SECOND EXAMPLE

In this second example, a flow of about 2 ton/h of (mainly) HDPE flakes (particles) was accelerated by a flow of air in a standard pneumatic transport pipe to about 25 m/s and then decelerated back to about 10-12 m/s by increasing the cross-sectional area of the air flow. Then the flakes were injected into a semi-circular stainless steel sheet (as shown schematically in FIG. 4, including particle receiving surface 51) with a diameter of about 0.6 m and a friction coefficient between flakes and steel of about 0.5. At the lower, downstream end of the sheet, the flake flow speed had been reduced to about 2-2.5 m/s and the coverage had been increased to over 40%, virtually free of overlap. At this speed, the flakes were transferred to a conveyor running at about 2.5 m/s.

### LIST OF REFERENCE SIGNS

1. Separation apparatus
2. Identifier
3. Identified particle
4. Group of particles
5. Affinity modifier
6. Non-identified particles
7. Separator
8. Layerizer
9. Rigid planar transport surface
10. Optical sensor
11. Affinity modifying particles
12. Catch surface
13. Particle delivery zone
14. Flight path
15. particle pickup zone
16. Zone with reduced air pressure/vacuum chamber
17. Air gap
18. Guide
19. Apertures
20. Transport trajectory
21. Mantle surface
22. Transport drum
23. Core
24. Apertures
25. Feed device
26. Fluidized bed of particles
27 Feed plate.
28. Further chamber
29. Catch drum
30. Mantle
31. Scraper
32. Guide plate
P1 Rotation direction transport drum
P2. Rotation direction catch drum
P3. Air flow
50. Transport path
51. Particle receiving surface
52. Layering apparatus
53. Particle accelerator
54. Downstream conveyor

1. A separation apparatus, comprising:
a layerizer arranged to bring a group of particles in a layer on a transport surface with a constant spatial relation of the particles relative to each other in the layer;
an identifier arranged to identify particles in the group of particles that have a specific property;
a separator arranged to separate the particles in the group based on a difference in affinity between the particles and the separator;
an affinity modifier arranged to modify said affinity for identified particles relative to non-identified particles in the group; wherein
the layerizer comprises a recirculating transport surface on which the particles of the layer are carried along a transport trajectory, wherein
the transport surface is arranged as a rigid plane so as to limit movement of the particles transverse to the transport trajectory.

2. The separation apparatus of claim 1, wherein the transport surface is arranged to rotate.

3. The separation apparatus of claim 2, wherein the transport surface is a mantle surface, in particular a rotating mantle surface of a drum.

4. The separation apparatus according to claim 1, wherein the transport trajectory includes a particle delivery zone where the particles disengage the transport surface to become airborne and travel along a flight path to the separator.

5. The separation apparatus according to claim 4, wherein the particle delivery zone includes a part of the transport trajectory where the transport surface moves downward.

6. The separation apparatus according to claim 1, wherein the transport trajectory includes a particle pickup zone where the particles engage the transport surface.

7. The separation apparatus according to claim 6, wherein the particle pickup zone includes a part of the transport trajectory where the inside of the mantle surface passes along a zone were air pressure is arranged to be lower than at the outside of the transport surface, and where particles are sucked onto the transport surface by ambient air passing through apertures in the transport surface.

8. The separation apparatus according to claim 1, wherein the layerizer comprises a fluidized bed of particles that is maintained along a part of the transport trajectory, in particular at a particle pickup zone where the particles engage the transport surface.

9. The separation apparatus according to claim 1, wherein the transport surface is provided with a plurality of apertures for passing air therethrough.

10. The separation apparatus according to claim 1, wherein the transport surface is a mantle surface that is arranged to rotate about a stationary support core of a drum.

11. The separation apparatus according to claim 1, wherein the transport trajectory includes an identification zone where the transport trajectory extends along the identifier.

12. The separation apparatus according to claim 1, wherein the separator comprises a catch surface on which identified particles in are caught, preferably a recirculating catch surface.

13. The separation apparatus according to claim 12, wherein the catch surface is a mantle surface that is arranged to rotate as a rigid plane.

14. The separation apparatus according to claim 1, wherein the affinity modifier modifies the affinity of the identified particles for the catch surface by applying affinity modifying particles to the identified particles, in particular to increase the affinity between the identified particles and the catch surface.

15. The separation apparatus according to claim 1, wherein the affinity modifier modifies the affinity of the catch surface for the identified particles by applying affinity modifying particles to the catch surface of the separator, in particular corresponding to that particles' position in the layer on the transport surface.

16. The separation apparatus according to claim 14, wherein the affinity modifying particles form a layer onto the identified particles or the catch surface.

17. The separation apparatus according to claim 14, wherein the affinity modifying particles include or are liquid droplets.

18. The separation apparatus according to claim 17, wherein the liquid droplets comprise water to form a moisture bridge between the identified particles and the separator.

19. The separation apparatus according to claim 1, wherein the affinity modifier comprises a printer head.

20-22. (canceled)

23. A method for separation of particles from a group of particles, comprising the steps of:
providing a group of particles that comprises particles with different properties, e.g. material, color, shape and/or size;
supplying the group of particles to a transport surface that moves along a transport trajectory as a rigid plane so as to bring the group of particles in a layer with a constant spatial relation on the transport surface;
identifying particles in the group of particles that have a specific property;
modifying an affinity between the identified particles and a separator relative to that affinity between non-identified particles and the separator using an affinity modifier;
separating the particles in the group based on their difference in the affinity with the separator.

24. The method according to claim 23, further including
casting the particles off the transport surface to become airborne and travel along a flight path to a catch surface of the separator.

25. The method according to claim 24, further including
modifying the affinity of the identified particles by applying affinity modifying particles to the identified particles and/or the catch surface to increase the affinity between the identified particles and the catch surface.

26-45. (canceled)
